(19) United States
(12) Patent Application Publication
(10) Pub. No.: US 2007/0110282 A1
(43) Pub. Date: May 17, 2007

(54) Protecting social security numbers from identity theft

(76) Inventor: Deena L. Millsapp, Chicago, IL (US)

Correspondence Address: DEENA LI MILLSAPP;# 405, 1220 N. STATE PARKWAY, CHICAGO, IL, 60610, US

(21) Appl. No.: 11/474,106

(22) Filed: Jun. 23, 2006

Related U.S. Application Data
(60) Provisional application No. 60/693,770, filed on Jun. 23, 2005.

(51) Int. Cl. G06K 9/00

(52) U.S. Cl. 382/115; 340/5.81; 705/72

(57) ABSTRACT

A method for providing an improved way for using a PIN system to verify, protect and lock social security numbers in a social security number verification PIN system wherein the user enters a temporary PIN and social security number into a PIN device or telephone line by means in which the temporary PIN and social security number are encrypted with computer generated random numbers to allow for safe communication with the social security number verification PIN system. Providing means in which the individual chooses and enters a secret PIN into the social security number PIN device or telephone line in which means are provided wherein the secret PIN is encrypted with computer generated random numbers to allow for safe travel to the social security number verification PIN system to communicate and match the secret PIN with its corresponding previously stored identity information to effect verification and allow the individual to prove ownership of the social security number.

### CROSS-REFERENCE TO RELATED APPLICATIONS

This application claims the benefits of PPA Ser. No. 60/693,770, filed Jun. 23, 2005 by Deena L. Millsapp.

### FEDERALLY SPONSORED RESEARCH

“non applicable”

### SEQUENCE LISTING, A TABLE OR COMPUTER PROGRAM LISTING

“non applicable”

### BACKGROUND OF THE INVENTION

This discovery relates to the identity verification industry, specifically a new and improved way to use a PIN system to verify, authorize and protect an identity.

### BACKGROUND OF THE INVENTION-PRIOR ART

The identity verification industry has many ways to verify and protect an individual's identity. The problem is the most important area of the identity is not verified or protected. This has led to identity theft and financial fraud in epidemic proportions. Today a personal identity could be verified by using a secret (PIN), National ID card, Smart Card ID, Internet ID certificate, Biometrics or a Social Security number. Let's now explore the way these identity verification solutions work and fail.

The website of www.purdue.edu states that Dr Attala invented the personal identification number system in information security management. He is known as the “Father of the PIN” The PIN system was born in 1973 and still is the standard form of identification in the banking industry to this day. We currently use the PIN to gain access to personal banking information from bank tellers, ATM machines or to make purchases with a debit card. The PIN concept is used in many other ways to verify and protect an identity but is called by other names such as passwords, access codes or secret codes. The PIN is a great identity verification tool but it doesn't protect the most important area of an identity. For this reason a criminal, illegal immigrant, or a terrorist can open fraudulent bank accounts or apply for bank loans and credit using stolen, illegally purchased or made up social security numbers. The Office of Consumer & Business Affairs, South Australia website list a few international identity theft cases. One important case states “The September 11 hijackers opened 35 American bank accounts without having legitimate social security numbers, none of which were checked or queried by bank officers. As a result the hijackers were able to move hundreds of thousands of dollars from the Middle East into the US through a maze of bank accounts commencing a year prior to the September 11 attacks” I'm sure the hijackers must have had debit cards and PIN numbers from those fraudulent bank accounts for easy access to their money. Using the PIN system in a different way will prevent this from happening. This could not have happened if the most important area of the identity was verified and protected.

Identification cards such as a state ID card, driver's license or a passport are usually obtained by showing other forms of identification such as a birth certificate, utility bill, or a social security number. State ID cards, driver's licenses and social security numbers are the main pieces of identity needed to open bank accounts, rent a car or apply for credit and loans. The problem today is these identity verifiers are easily counterfeited and fraudulently used. NPR's Larry Abramson on the morning edition dated Jul. 26, 2002, reported on Jun. 9 2006 says “the Sept 11 hijackers who made up phony social security numbers to open illegal bank accounts also used phony made up social security numbers to obtain driver's licenses.” Another problem stated on NPR's website dated Jun. 9, 2006 titled “Protecting Social Security Numbers” states “Fake Social Security Cards” and stolen social security numbers have allowed millions of illegal immigrants to enter the work force.” Identification cards are not what they use to be. On the website of the Office of Consumer & Business Affairs, South Australia is listed another example of why we need a better way to protect all areas of identity verification. “A suspected alQa'ida terrorist was arrested in Canada in July 2002 and has been linked to an Australian passport found in the homes of two alleged cohorts. The suspect was wanted in the Netherlands on a charge of conspiring to blow up the US embassy in Paris and for supplying a fake passport to two former roommates who were found in possession of 41 other fake passports and identity papers.” Wow! In other words a personal identification card holds the power to the American dream or America's doom. These stolen benefits and terrorist acts are a direct result from using stolen or made up social security numbers to obtain fraudulent driver's licenses and passports. Using the PIN system in a new way will protect the bottom line and the most important area of an identity preventing the ability to obtain or use fraudulent national ID cards.

National ID cards are slowly upgrading to a Smart Card ID. The smart card has a computer chip in it that makes this type of identification card a more secure way to store a personal identity on a card. The idea of incorporating a computer chip into an identification card was born in 1968. The encryption ability of the integrated circuits inside the smart card greatly increases its security for holding personal identity information. Smart cards are said to be tamper resistant so counterfeiting a smart card identification card would be a challenge. This is heading in the right direction for reasons stated above. However if the most important area of an identity remains unprotected, stolen or made up social security numbers could still obtain a fraudulent smart card ID promoting business as usual for the criminal, illegal immigrant or terrorist. For example: A national smart card ID is demonstrated in the Chicago Sun Times dated Tuesday, Aug. 16, 2005 written by: Rodger Yu, titled “Smart Card Passports Gaining Clearance” and it states “If you have a U.S. passport, get ready to upgrade it to the digital variety. U.S. passports already carry advanced coding and digitized information but the next step has been to embed a “smart card” chip. Because the chip's data can't be altered, proponents say forging passports will be virtually impossible.” Ok this is good, a harder to counterfeit digital passport but as the article states a skimming device standing within one inch of the smart card passport can recover, read and record an individual's personal information. The State Department however, is addressing this issue by adding a layer of protection by encrypting the information so it's readable only by authorized devices. Good move but the most important area of an identity is still unprotected allowing a criminal, illegal immigrant or terrorist to use stolen personal identity to obtain a fraudulent smart card passport still. Smart Cards are more than identification cards. They are debit cards, credit cards, Internet ID certificates, and moving in the direction to becoming a driver's license and social security card. Because the smart card has a computer inside of it makes it interoperable with the PIN system technology. Protecting the most important area of an identity on or inside of the smart card using the classic PIN system will prevent a criminal, illegal immigrant or terrorist from using stolen identity to obtain fraudulent identification cards as well as prevent the use of stolen identity to use credit or apply for credit and loans.

The Internet is a very complex and sometimes very hostile world for making financial and other secure business transactions. An individual making purchases or applying for credit and loans over the Internet is not always properly verified and can't always be trusted. Stolen identity can be used to create fraudulent ID certificates in the electronic business world as well. The website of www.willthegeek.com gives one good example of how the ID certificate works in an e-business transaction. “A CD company publishes its public key as all participants of the Internet have to do. When ordering CD's from the CD Company, the individual uses the CD Company's public key to encrypt and send his/her credit card information knowing it will be safe. The CD Company receives and decrypts the individual's credit card information using its own private key and sends the CD order to the individual. Ah! Good old shopping made easy right? Right! What if the CD purchase is being made using a stolen credit/debit card or a credit/debit card obtained using a stolen or made up social security number? The most important area of an identity is unprotected in the electronic business world as well. Internet shopping is absolutely necessary but identity theft and financial fraud is growing at alarming rates! The most popular Internet identity theft scams today are account takeover, false merchant site, site cloning, and fraudulent e-business transactions. An identity thief takes over a credit card account by stealing the credit card information to change the name and address, then call to report the credit card lost or stolen to request a new card replacement. False merchant sites happens when an identity thief sets up a phony website to accept credit cards as proof of age and after the credit card information has been gathered the criminal goes shopping on real merchant sites. Site cloning happens when a merchant's website is cloned to look and act as real e-business transactions including an e-mail receipt but the purchases never arrive. Fraudulent e-business transactions are the most popular Internet identity theft problems in the electronic business world today. This happens when a criminal uses stolen credit card accounts or credit cards obtained using stolen identity to make purchases on e-business websites. Nevertheless none of these scams would be successful if the most important area of the identity is properly verified and protected.

Biometrics uses a body part such as a thumbprint or iris scan to verify an identity. Jewel-Osco is a grocery store chain here in Chicago that recently introduced a new biometrics technology called e-check “pay by touch”. This technology allows an individual to pay for groceries by pressing the index finger into a finger reader device to take tiny measurements of the finger for verification purposes. Afterwards the individual enters a seven digits number usually a telephone number into a separate PIN code device for further verification of his/her identity. After the identity is successfully verified the deduction is taken out of the individual's checking account to pay for the groceries. The e-Check technology is a great additive to the identity verification industry but it still does not protect the most important area of an identity. It is highly possible that an individual using the e-Check system could be a criminal, illegal immigrant or terrorist who obtained the checking account using a stolen or made up social security number. If the Sept 11 hijackers opened 35 American bank accounts using made up social security numbers then anyone could do it. We need the root core of our identity verified and protected to prevent this from happening. Using the classic PIN system in a better way will guarantee that the individual using the identity truly is the owner of the identity.

President Roosevelt signed the Social Security Act Aug. 14, 1935 and the first social security numbers were issued in 1936 exactly seventy years ago. The social security number is the first classic example of an identity verifier and is the most important area of the identity today! The Root! The Core! The Bottom Line! For this reason social security numbers should be verified, protected and locked to prevent any unauthorized use. Social security numbers are used to obtain national identification cards, jobs, open bank accounts or to apply for credit and loans. The criminal desperately needs stolen or illegally purchased social security numbers to apply for and fraudulently obtain credit cards and loans. The terrorist absolutely need stolen, made up or illegally purchased social security numbers to successfully finance terrorist sneak attacks, rent vehicles and hide their true identities. Illegal immigrants absolutely need stolen, borrowed or illegally purchased social security numbers to survive in a country undocumented. Congress is moving to replace the paper social security card with the harder to counterfeit version. This is the national smart card ID as mentioned earlier and could work in conjunction with the newly discovered social security number PIN system to protect and lock social security numbers preventing financial fraud and identity theft.

### BRIEF SUMMARY OF THE INVENTION

Social security numbers are the most important area of an identity and should always be verified, protected and locked to prevent fraudulent use. Using the PIN system in a different way will provide maximum security for social security numbers allowing only the legal owner of the social security number to unlock its use for legitimately verified business transactions.

### BRIEF DESCRIPTION OF THE SEVERAL VIEWS OF THE DRAWINGS

FIG. 1—My Credit Card Department Store

FIG. 2—True Identity Banking

FIG. 3—Really You Car Dealership

FIG. 4—Who Are You Car Rental Inc

FIG. 5—My Identity Mortgage Company

FIG. 6—My E-Check Digital Fingerprint Grocery Store

FIG. 7—Genuine Owner Credit Card Inc

FIG. 8—Legal Identity Utilities Corporation

FIG. 9—It's Me For Real ID Act

FIG. 10—Global Border Control

FIG. 11—Interoperable Smart Card USA

FIG. 12—Legal Immigrant USA

FIG. 13—Owner Verified Credit Check

FIG. 14—Account Takeover Is History.com

FIG. 15—Stop Fraudulent E-Business Transactions

FIG. 16—Proven Identity Instant Credit

### DETAILED DESCRIPTION OF THE INVENTION

To successfully protect social security numbers from financial fraud and identity theft, I visualize a secret PIN assigned to every eligible legal citizen's social security number worldwide. Using the classic PIN system in this way is a new and surprising benefit to our societies! By designing a social security number PIN device and telephone PIN system that communicates with a social security number central verification computer PIN system, will provide maximum security for social security numbers everywhere! The social security number PIN system puts the power in the hands of the legal owner of the social security number while locking out identity thieves.

How the social security number PIN system, PIN device and secret PIN works is best described by: prior art reference: Kenneth Weiss, U.S. Pat. No. 5,023,908, filed Apr. 21, 1989 which states “In a personal identification system of the type wherein a user is provided with a device generating a unique, time-varying, non-predictable code, with a non-secret identifying code and with a secret PIN, the non-predictable code at a given instant and the PIN being provided to a central verification computer to effect verification, apparatus for providing improved security of the PIN”. In the case of the social security number PIN system it would actually provide improved security for social security numbers.

How the social security number PIN system works when verifying an identity over telephone lines is also described in the prior art reference: Kenneth Weiss, U.S. Pat. No. 5,023,908, filed Apr. 21, 1989 which states “A procedure is thus provided wherein user verification may be obtained using the simple and inexpensive procedure disclosed in the parent applications while still providing a high level of security for the user PIN. This security is achieved since the user PIN is never available on an open line, which could be tapped except in the form of a word which is a mixture of the PIN with a non-predictable code and which is virtually impossible to decipher.”

The social security number PIN system will house the US security codes (PIN) and their corresponding social security numbers in a similar way to the prior art abstract reference U.S. Pat. No. 5,023,908, April 89, states “A method and apparatus for providing improved security for a personal identification number (PIN) in a personal identification and verification system under strict extreme protective measures.” Providing an individual with means for proving ownership of his/her social security number by sending his/her secret US security code to a central verification computer PIN system either directly (electronic device) or over a telephone line similar to the prior art claim reference: U.S. Pat. No. 5,023,908, “the unpredictable code at a given instant and the PIN being provided to a central verification computer to effect verification, apparatus for providing improved security of the PIN comprising” would allow citizen's to enter the secret US Security Code (PIN) into an electronic device for the purpose of verifying and proving ownership of the social security number to apply for or use credit in his/her name, or call into an organization or business and enter the US Security code (PIN) into the telephone line for the purpose of verifying and proving ownership of the social security number to apply for or use credit in his/her name. A system designed in this way will also provide the means in which the social security number will be automatically protected and locked when not in use preventing financial fraud and identity theft.

To begin the process of assigning a secret PIN to an individual's social security number, a temporary PIN needs to be obtained first. I'd prefer a system similar to the one used by the Social Security Administration. Which states, “establishing a password involves three steps by Internet: 1. To create a permanent password, a temporary password request code letter needs to be applied for. 2. Wait at least 15 days for your temporary password request letter to come by mail. 3. Create the permanent password using the directions in the letter. To create a permanent password by phone there are also three steps. 1. Call the phone number given, listen carefully to the menu choices and when you hear to request, create or change a password, choose number one to request. This is currently how the Social Security Administration assigns passwords to online customers. I visualize linking with the Social Security Administration to mail out temporary US security codes. Linking with the Social Security Administration in this way will allow maximum security that the US security codes are assigned to the rightful legal owner of the social security number. After an individual has obtained his/her temporary US security code, means will be provided for the individual to create his/her permanent US security code by phone or in person.

After obtaining a temporary US security code preferably by linking with the Social Security Administration, the individual can create his/her permanent US security code either in person or by telephone. If in person the individual being provided with a social security number PIN device will enter the temporary US security code into the PIN device followed by his/her social security number to encrypt with computer generated random numbers. Means will be provided in which the encrypted temporary US security code, social security number and computer generated random numbers are sent to communicate with the social security number central verification computer PIN system where it's stored permanently. Immediately afterwards the individual enters a secret permanent US security code of his/her choice into the social security number PIN device where means are provided for the secret permanent US security code to encrypt with computer generated random numbers to allow for safe communication with the social security number central verification computer PIN system to match with other previously stored identifying information to effect verification and prove ownership of the social security number safely authorizing and unlocking its use.

To create a permanent US security code by phone I'd prefer a system similar to, after receiving a temporary US security code, the individual calls a phone number and an automated voice message system prompts the individual to enter the temporary US security code and social security number into the telephone number keypad for identification purposes. Immediately following, the individual is prompt to enter a permanent US security code of his/her choosing into the telephone line to communicate with the social security number telephone verification computer PIN system where it is stored permanently. Afterwards, the individual is prompt to enter the US security code once more to verify the accuracy of the identity. The social security number telephone verification computer PIN system is a powerful way to verify an identity over the telephone. This to will provide a solution that protects the core root of an identity preventing financial fraud and identity theft.

I'm currently still working on the US disposable security codes concept for Internet shopping. However, the phone system side of the social security number PIN system will cover the Internet side in the mean time. There is no stronger identity verifier than the social security number. Combining an off line social security number telephone verification process for each e-business transaction before credit cards can be used and merchandise can be delivered will provide a good old fashion way of doing business while preventing financial fraud and identity theft. Every individual will need to prove ownership of the social security number before credit cards are used and merchandise delivered. The many ways the social security number PIN system protect and lock social security numbers is amazingly demonstrated in the detailed description of the drawings figures below.

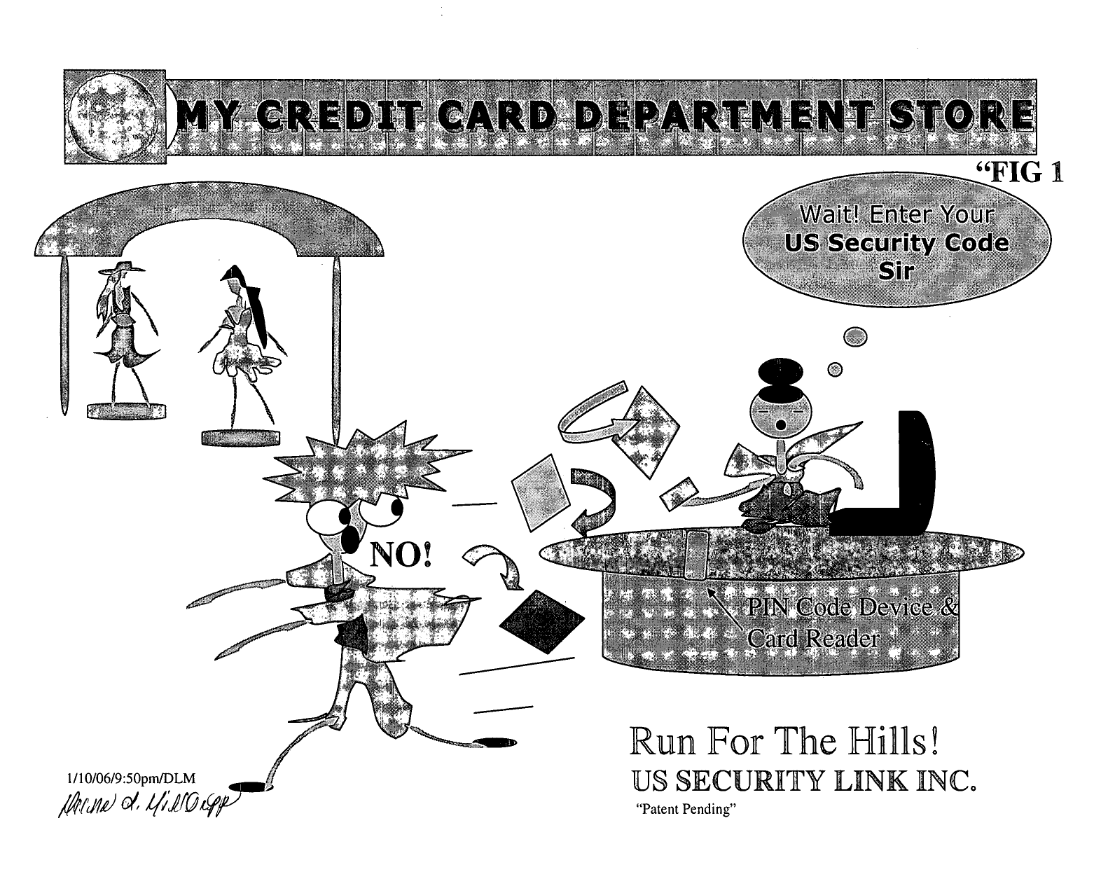

“FIG. 1 shows an identity thief has walked into a major department store with a credit card obtained using an unsuspecting individual's stolen social security number. After swiping the credit card the clerk asked the identity thief to enter the US security code that protects the social security number on the credit card account into the social security number PIN code device which communicates with the social security number central verification computer PIN system to prove ownership of the social security number to verify, authorize and unlock its use. Unable to provide the correct PIN to unlock the use of the social security number on the credit card account therefore protecting the credit card, the identity thief out of nervousness screams NO!, and flees defeated.

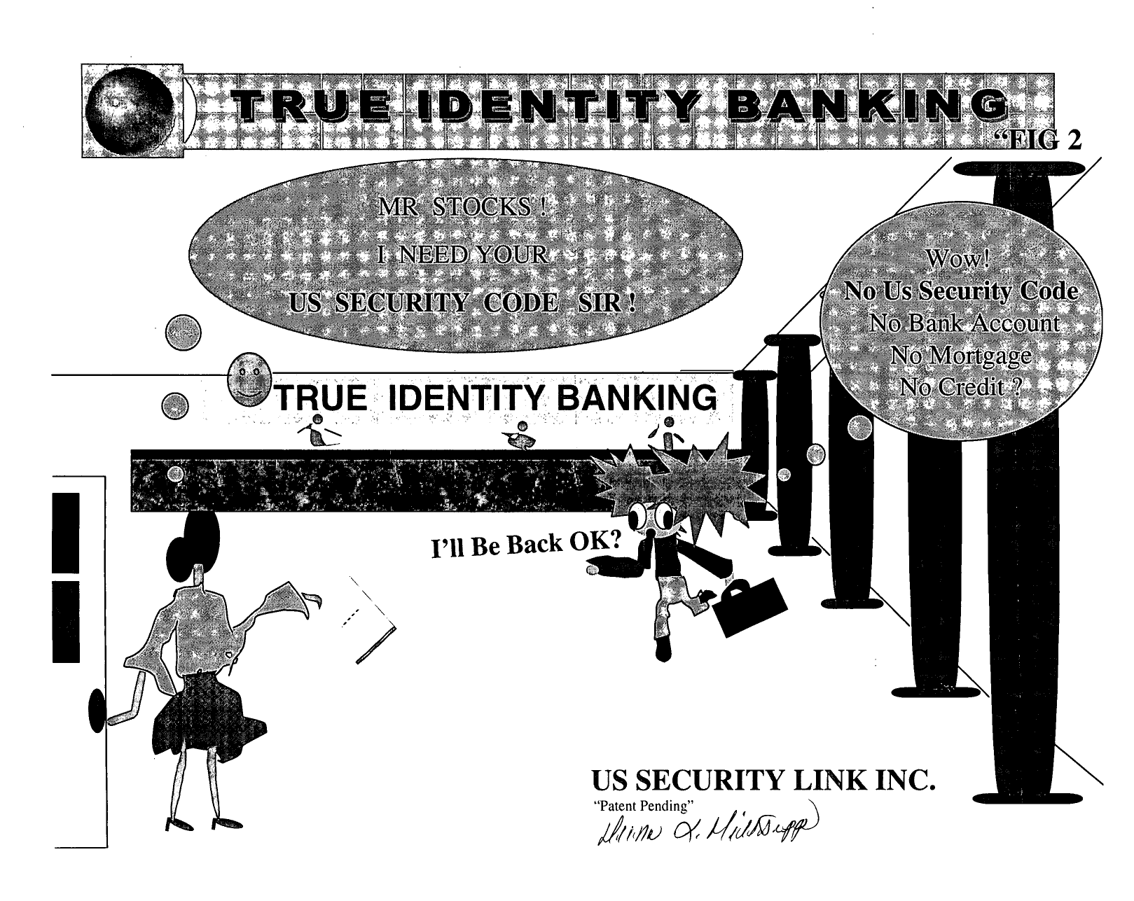

“FIG. 2 shows that an identity thief attempted to open a bank account and apply for a loan using a made up social security number. When the banker asked the identity thief to enter the US security code that protects the social security number into the social security number PIN code device to communicate with the social security number central verification computer PIN system to prove ownership of the social security number to verify, authorize and unlock its use, the identity thief quickly runs out of the office and the Banker immediately followed asking again for the US security code.

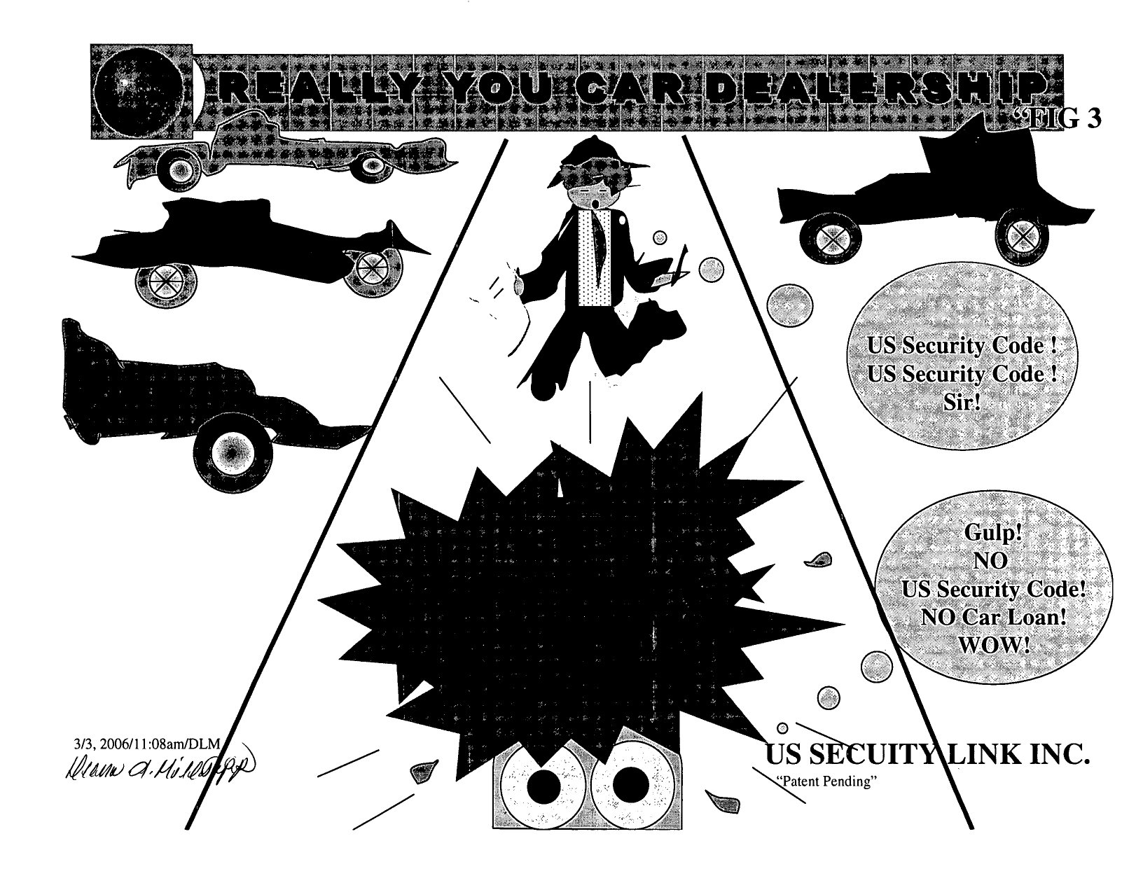

“FIG. 3 shows the identity thief obviously filled out a fraudulent new car loan application using a stolen or illegally purchased social security number. In the back office the identity thief was asked to enter the US security code that protects the social security number into the social security number PIN code device to communicate with the social security number central verification computer PIN system to verify, authorize and unlock the use of the social security number to apply for the car loan. Somehow the identity thief managed to slip away from the car salesman unnoticed and thought he/she had gotten away. With one hand on the door the car salesman was right behind asking again for the US security code.

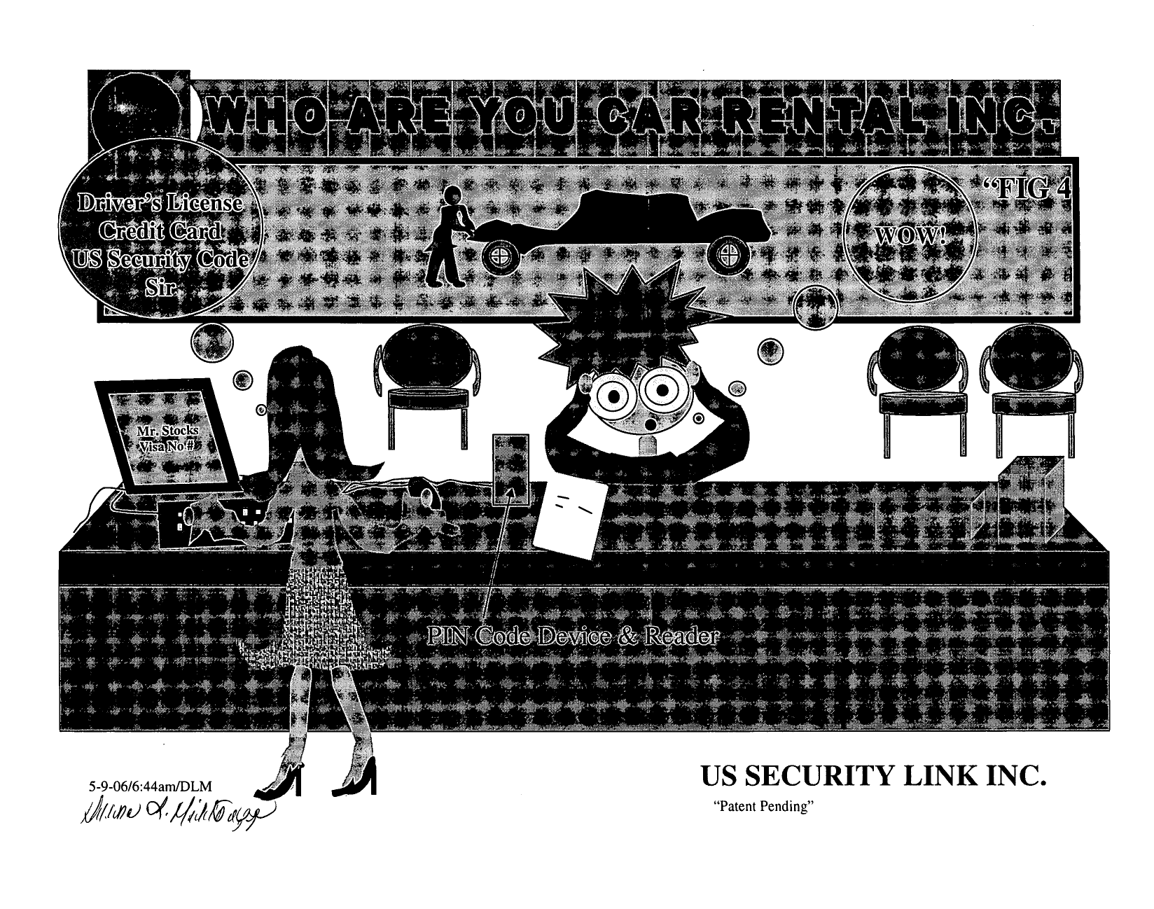

“FIG. 4 shows a criminal, illegal immigrant or terrorist attempting to rent a car using a stolen credit card or a credit card obtained using a stolen social security number and a fraudulent driver's license. The car rental clerk asked the identity thief to enter the US security code that protects the social security number on the credit card account and driver's license into the social security number PIN code device to communicate with the social security number central verification computer PIN system to verify, authorize and unlock the use of the social security number on the credit card and driver's license. Unable to provide the US security code that unlocks the use of the social security number on the credit card account and driver's license, the criminal, illegal immigrant or terrorist is frozen, paralyzed and defeated.

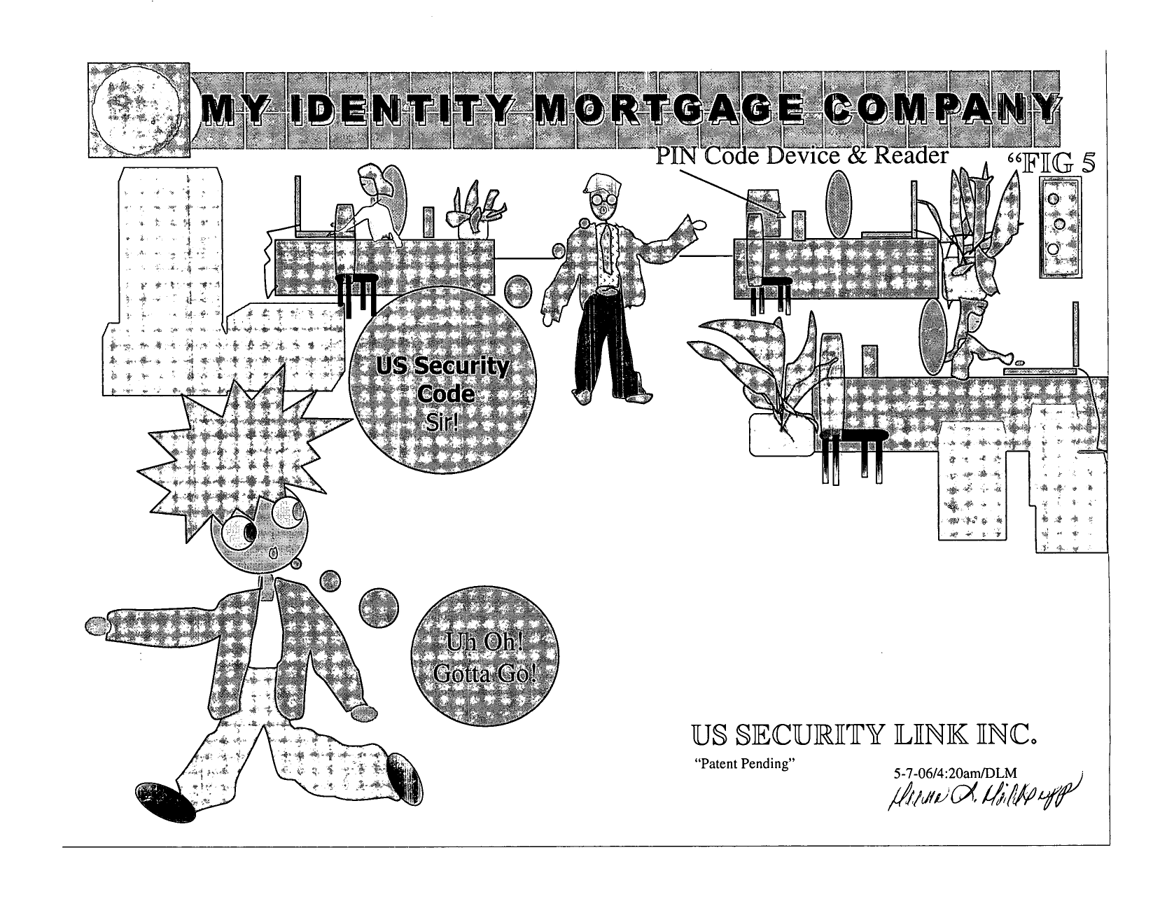

“FIG. 5 shows another industry to benefit from the social security number PIN system. An identity thief went to. a mortgage company to apply for a mortgage loan using a stolen or illegally purchased social security number. Before the mortgage application process can begin the mortgage broker asked the identity thief to enter the US security code that protects the social security number into the social security number PIN code device to communicate with the social security number central verification computer PIN system to verify, authorize and unlock the use of the social security number. The identity thief simply gets up and walks away but it didn't stop the mortgage Broker from asking again for the US security code.

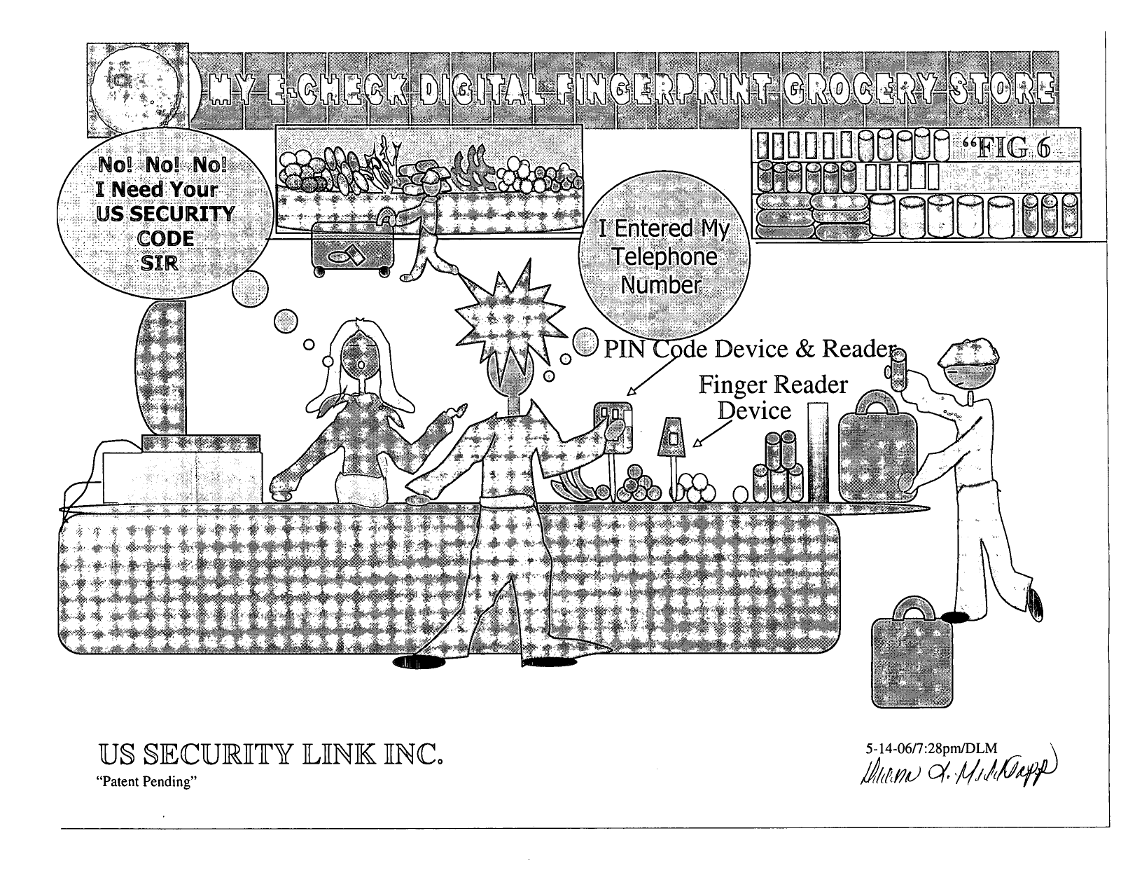

“FIG. 6 demonstrates how the e-Check PIN system which uses a combination of biometrics technology fails to protect the most important area of an identity. The individual using the e-Check system could actually be an identity thief who opened the bank account using a stolen or made up social security number. The e-Check “pay by touch” technology has been recently introduced. FIG. 6 shows an identity thief checking out groceries using the e-Check “pay by touch” system. The system requires a finger measurement and a seven digits PIN number. Because this system doesn't verify and protect the social security number on the checking account, the grocery store clerk ask the identity thief to enter the US security code that protects the social security number into the social security number PIN code device to communicate with the social security number central verification computer PIN system to verify, authorize and unlock the use of the social security number on the checking account before payment is authorized.

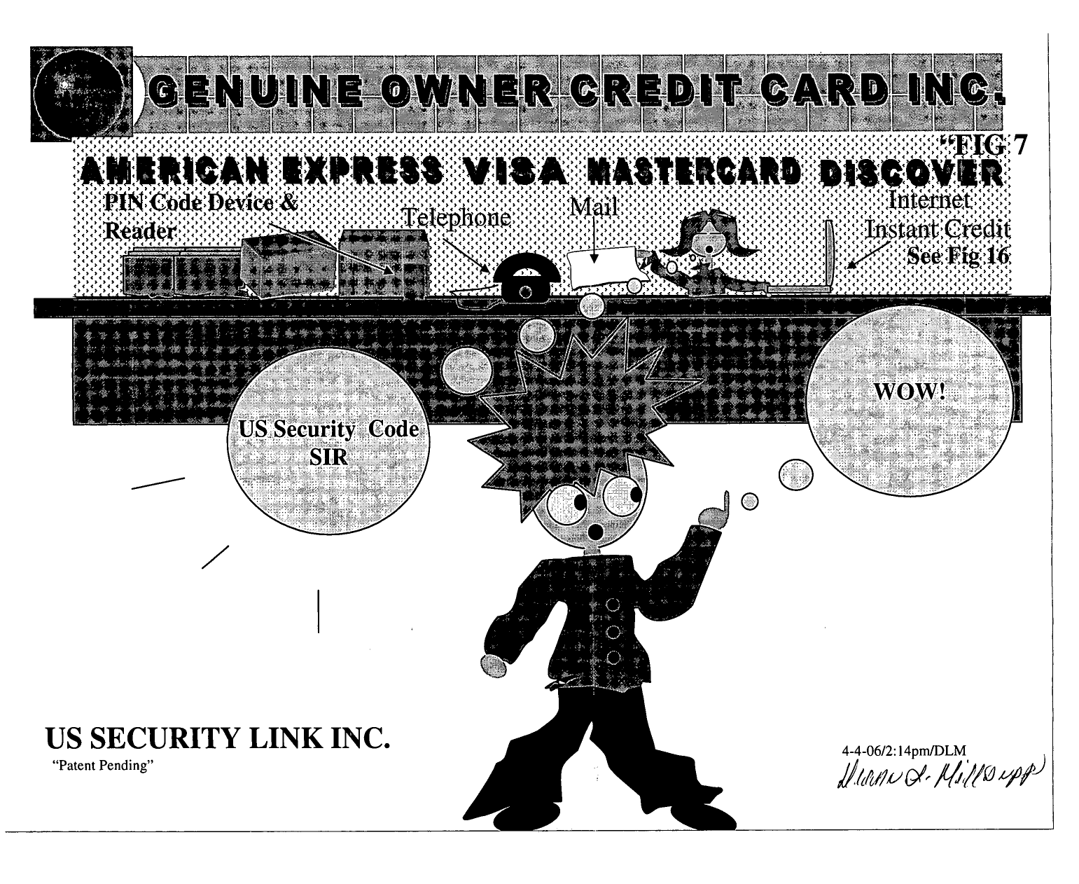

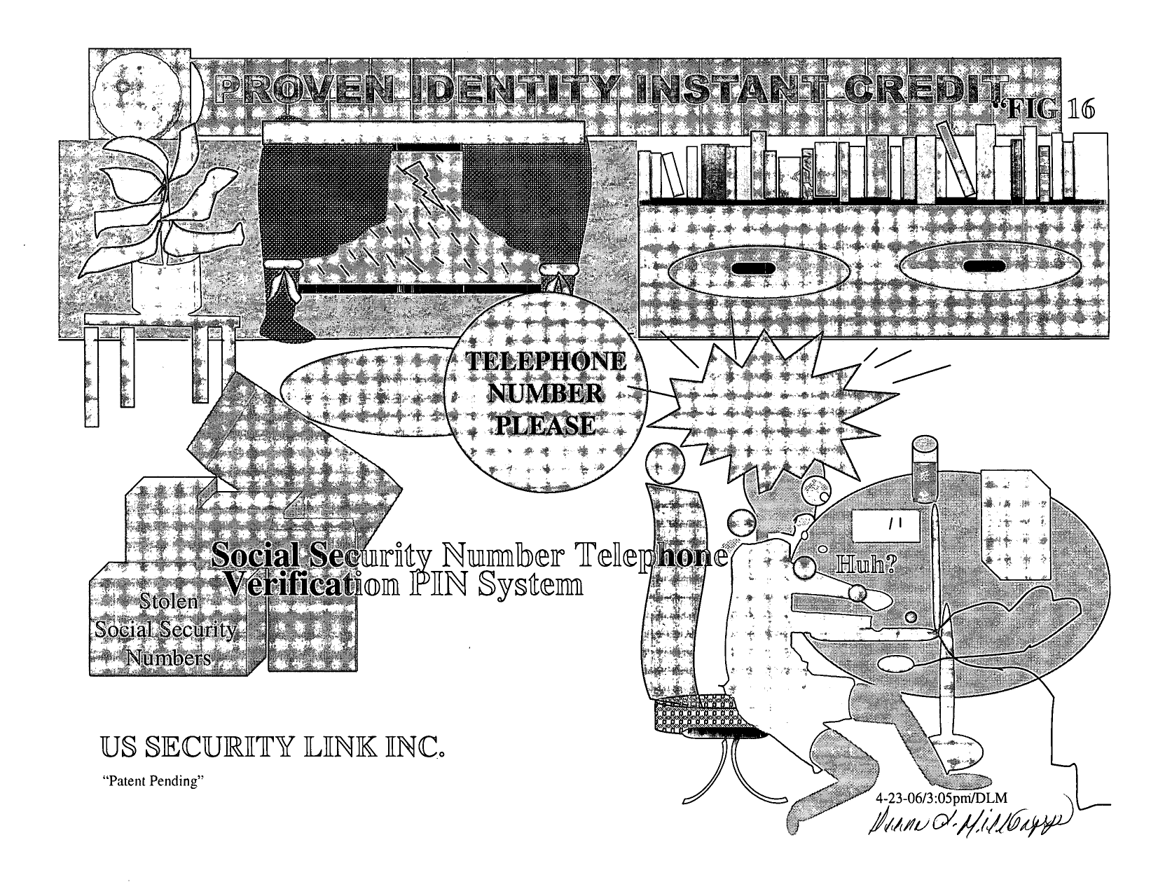

“FIG. 7 is an abstract view of the many ways a credit card can be applied for. Whichever way the major credit card is applied for either through a bank, by mail, over the Internet see FIG. 16, or by phone the social security number PIN system should be used to prove ownership of a social security number before proceeding to process a credit application. This could be done in person by entering the US security code that protects the social security number into the social security number PIN code device to communicate with the social security number central verification computer PIN system to verify, authorized and unlock the use of the social security number to apply for credit, or this could be done using the telephone by entering the US security code that protects the social security number into the telephone line to communicate with the social security number telephone central verification computer PIN system to verify, authorize and unlock the use of the social security number to apply for credit. When a credit application is received by mail, the individual should receive a call asking that his/her US security code be entered into the telephone line to communicate with the social security number telephone central verification computer PIN system to prove ownership of the social security number before the credit card application process can continue.

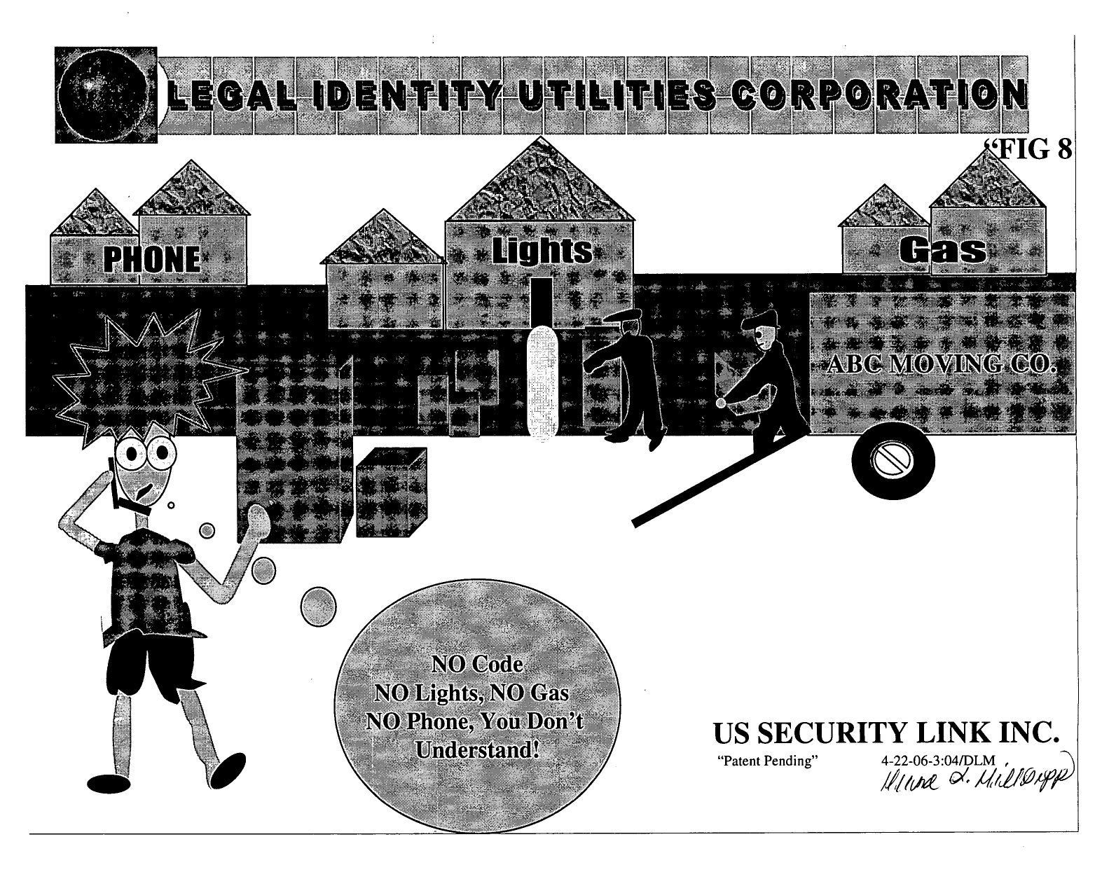

“FIG. 8 shows that after arriving to the new home, the identity thief had no lights, gas or phone service which was ordered before moving to the new address. Totally livid, the identity thief calls the utility company to ask why service had not been turned on. The utility clerk explains that there must have been some kind of misunderstanding and she would be happy to help. The utility clerk asked for the US security code that protects the social security number to be entered into the telephone line to communicate with the social security number telephone central verification computer PIN system to verify, authorize and unlock the use of the social security number to order utility service. If the US security code is not given, utility service will be denied. Unless the US security code is proven to be extremely safe to use on mobile phones, I will advise against it. However, if need be the individual could change the secret US security code at anytime through a social security number telephone voice automated PIN system.

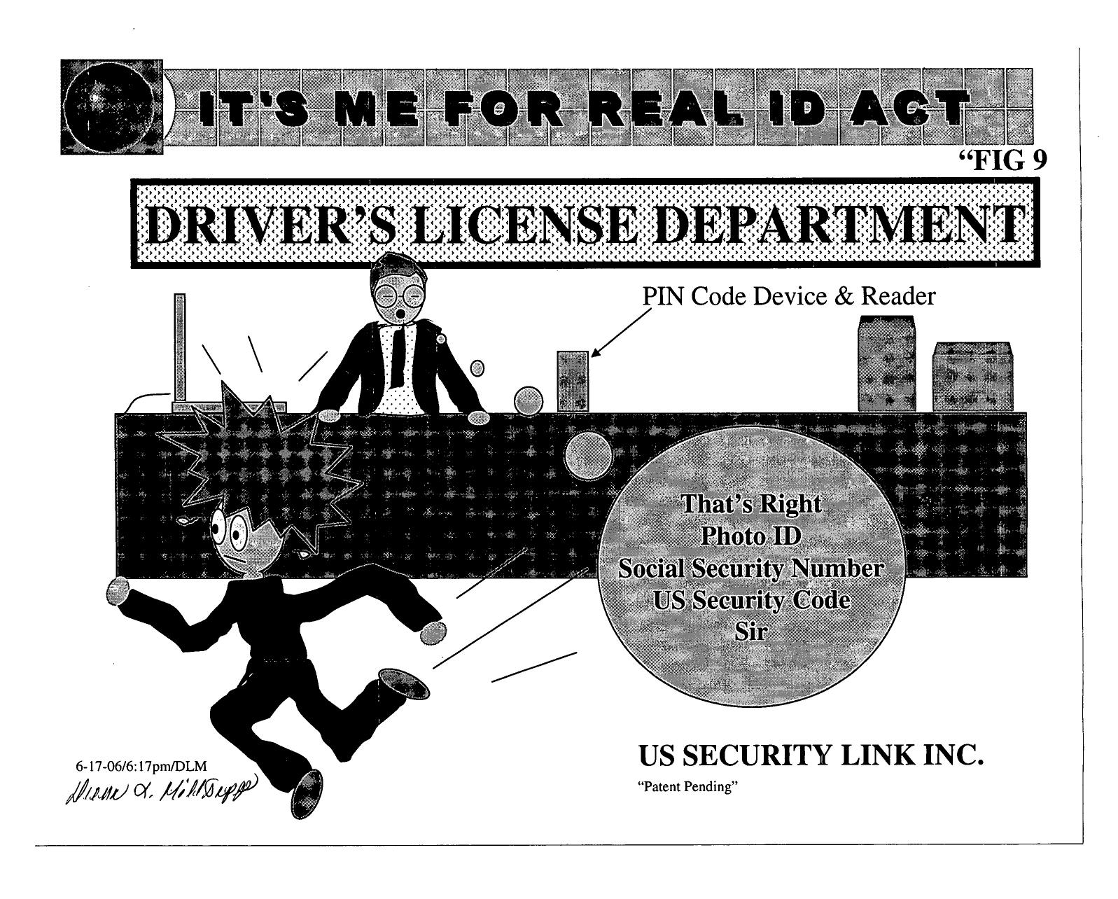

“FIG. 9 is a scene concerning a serious national security problem. The Sept 11 hijackers used made up phony social security numbers to obtain driver's licenses. FIG. 9 shows a criminal, illegal immigrant or terrorist attempting to obtain a driver's license using a made up social security number. When the clerk asked the criminal, illegal immigrant or terrorist to enter the US security code that protects the social security number into the social security number PIN code device to communicate with the social security number central verification computer PIN system to verify, authorize and unlock the use of the social security number to apply for a driver's license, the criminal, illegal immigrant or terrorist quickly runs out the door defeated.

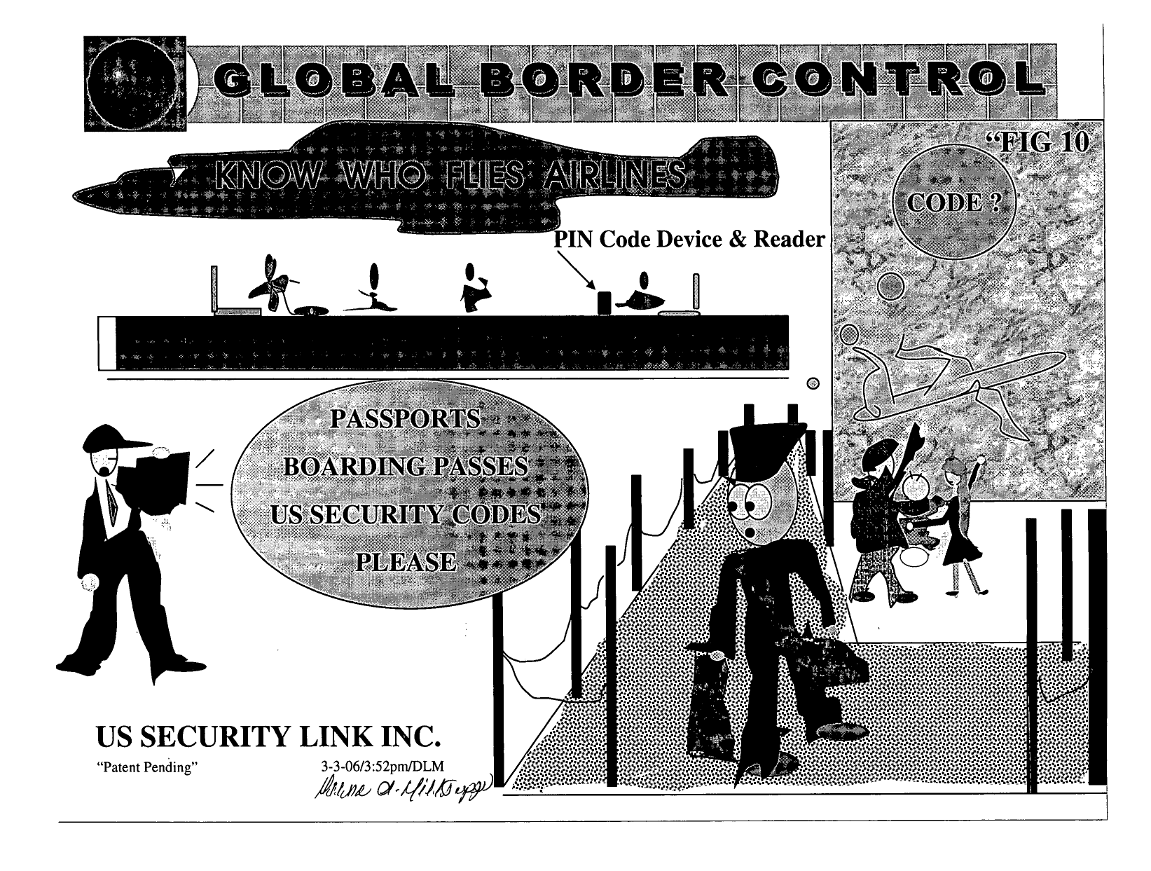

“FIG. 10 demonstrates how the social security number PIN system will help strengthen border security. Al-Qa'ida terrorist were in possession of 41 fake passports and identity papers. Since the new e-Passport does not verify or protect the most important area of an identity it should have means in which to interoperate with the social security number PIN system to verify ownership of the social security number used to obtain the e-passport. FIG. 10 shows that the criminal, illegal immigrant or terrorist has been denied boarding privileges because he/she could not prove ownership of the social security number by entering the US security code that protects the social security number into the social security number PIN code device to communicate with the social security number central verification computer PIN system to verify, authorize and unlock the use of the social security number on the e-passport to safely allow a verified identity to board an airplane.

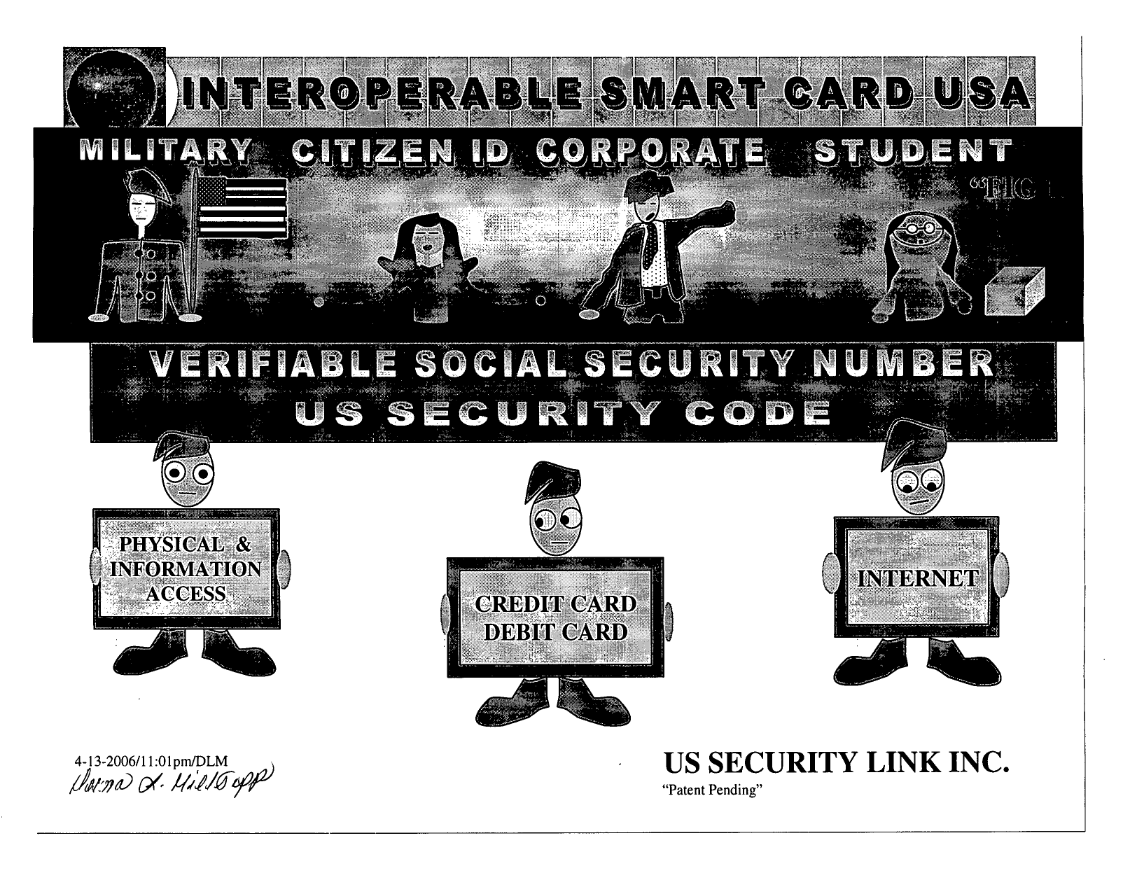

“FIG. 11 shows the many ways the computer Smart Card has transformed into National ID cards, Military ID cards, Employee ID cards, Student ID cards, Internet ID certificates, Bank cards, Credit cards, Security Access cards, and could become much more. Smart cards are either contact or contact-less. Contact smart cards are made with a magnetic stripe on the back of the card used to swipe through a card reader PIN system to effect verification. Contact-less smart cards relies on the radio frequency technology by holding the card over a designated area on a card reader machine to effect verification. Either way, combining the social security number PIN system with the smart card technology will allow the social security number on or inside the smart card to be verified, protected and locked by the US security code. The social security number PIN system will make sure that the legal owner of the social security number is the only one who can unlock the use of the social security number contained on or inside any kind of smart card identifier.

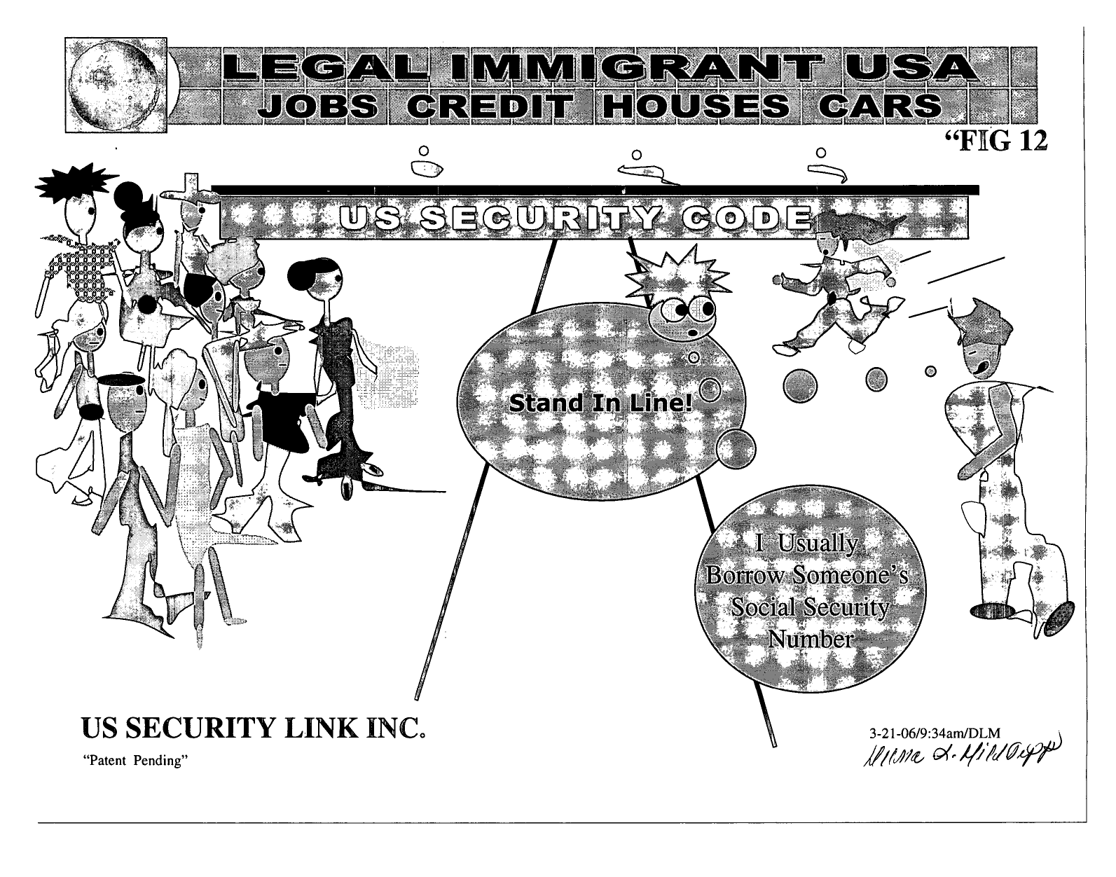

“FIG. 12 President Roosevelt signed the Social Security Act and distributed the first social security cards in 1936, one social security number per individual. The social security number is the most important area of an identity but currently it's being terribly abused. Today, illegal immigrants are using stolen or illegally purchased social security numbers to apply for jobs, credit, home loans and car loans. The social security number PIN system will help fix this border security problem. FIG. 12 shows illegal immigrants running to the Immigration Authority to get legally registered in America or abroad because social security numbers can no longer be used fraudulently. The social security number PIN system can interoperate with the new social security number smart card ID technology by swiping the new social security number smart card ID through the social security number PIN device to communicate with the social security number central verification computer PIN system to prove ownership of the social security number when applying for jobs, credit or loans.

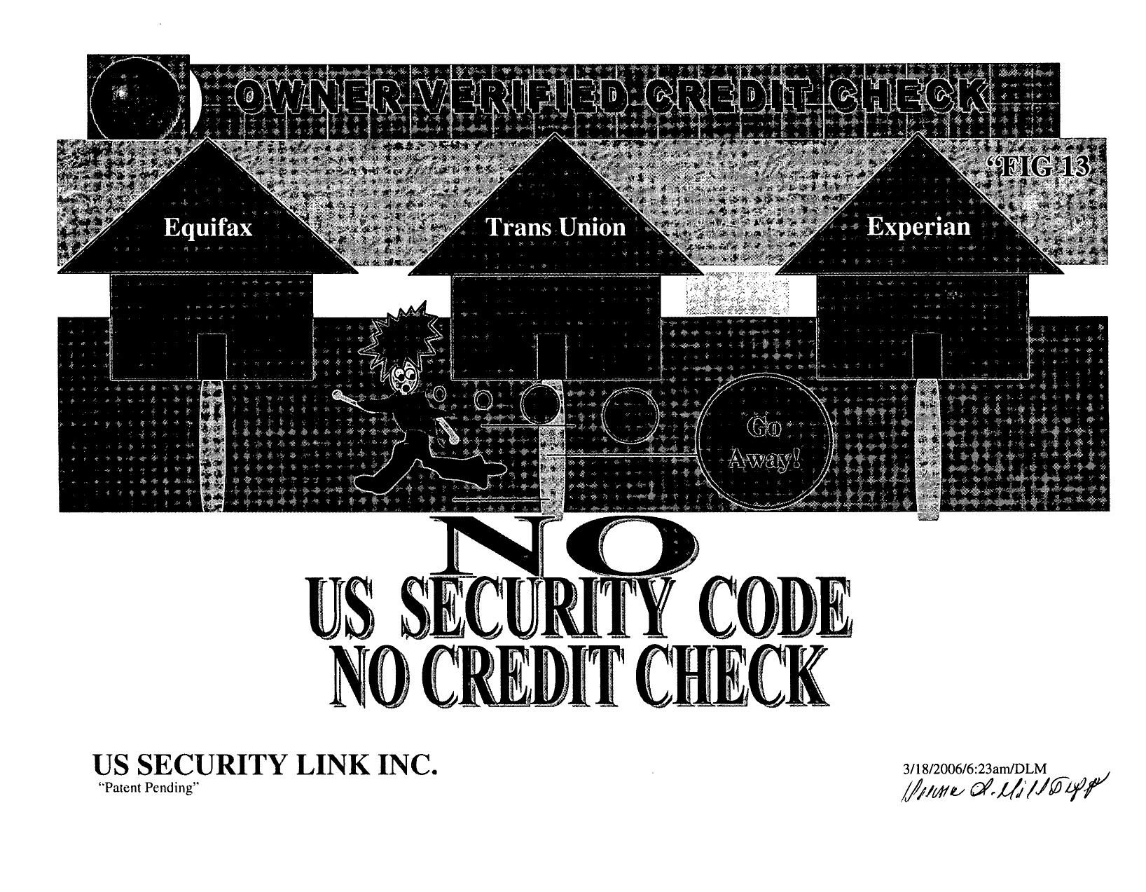

“FIG. 13 demonstrates an angry identity thief who is frustrated about needing to prove ownership of the social security number first, before a credit check can be requested when applying for credit or loans and wants the new social security number PIN system to go away. The social security number PIN system offers a better alternative than permanently freezing a credit report. The correct US security code puts the control in the hands of the legal owner of the social security number to lock and unlock its use in a given instant to apply for credit or loans preventing financial fraud and identity theft.

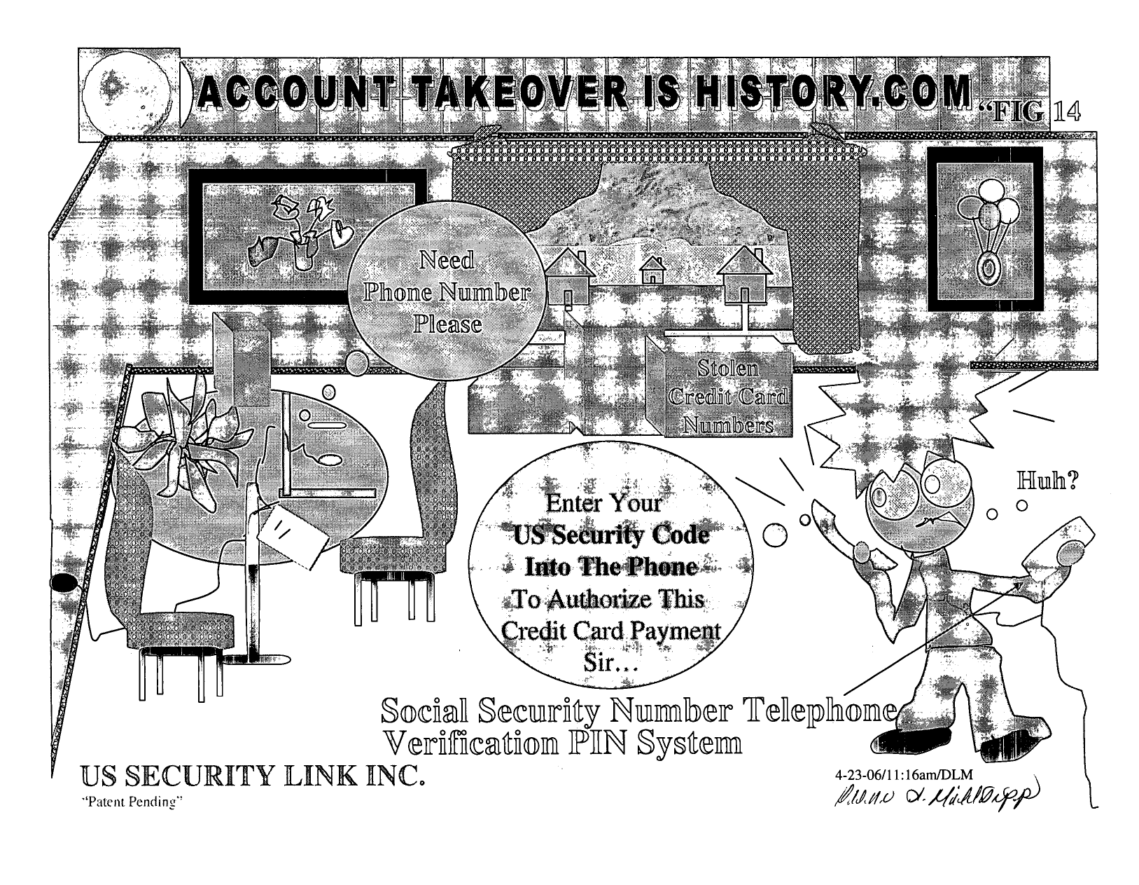

“FIG. 14 shows a quick view of how the social security number telephone verification computer PIN system can prevent financial fraud and identity theft when making purchases over the Internet. FIG. 14 shows that an identity thief has gone on a shopping spree using a stolen credit card. The identity thief believes the order has been processed for delivery and is now shopping on another e-business website using a different stolen credit card when the phone rang. It was a representative from US Security Link Inc. and/or the Retailer. The identity thief was asked to enter the US security code that protects the social security number on the credit card account into the telephone line to communicate with the social security number telephone central verification computer PIN system to unlock the use of the social security number on the credit card account to verify and authorize merchandise to be paid for and delivered. The identity thief has no knowledge of the US security code that protects the social security number on the credit card account because the credit card is stolen therefore merchandise will not be delivered.

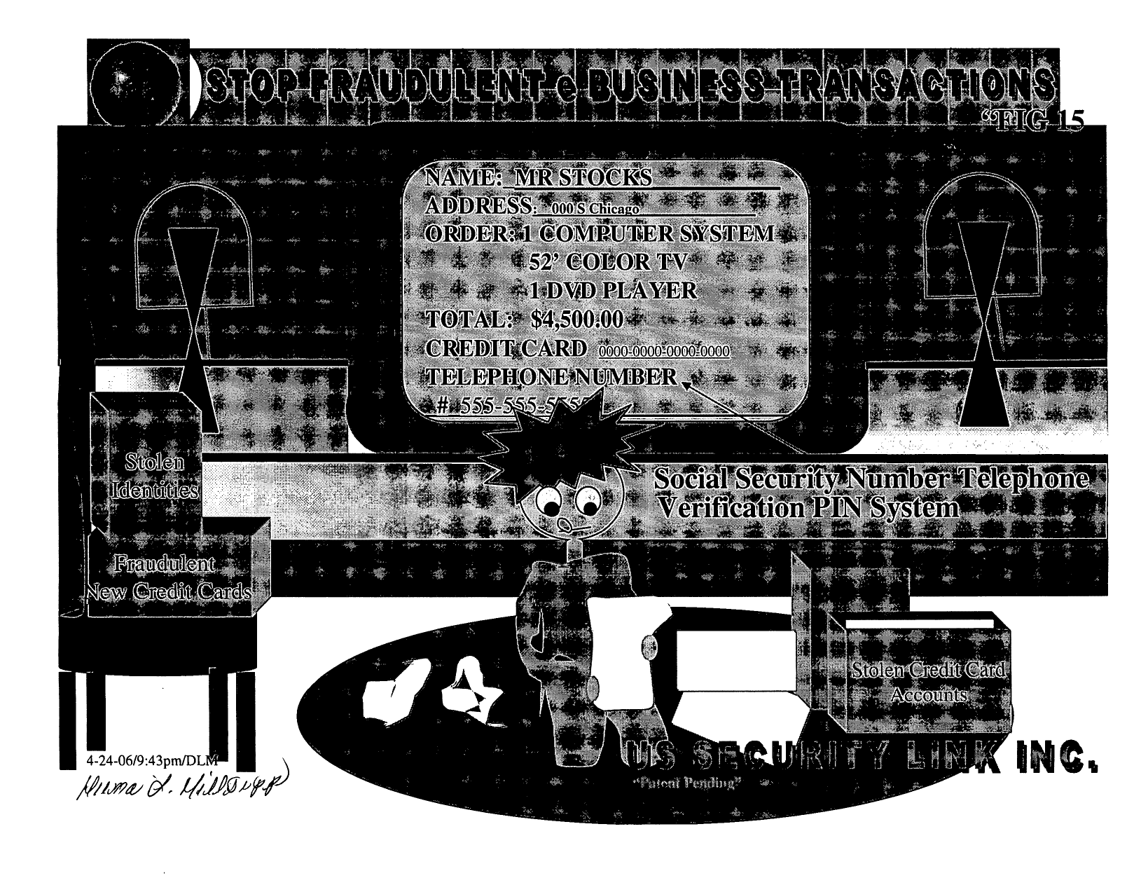

“FIG. 15 demonstrates how adding one more step to the on-line verification process for Internet shopping could prevent financial fraud and identity theft. After a purchase has been made on the Internet the individual will receive a call and be asked to enter the US security code that protects the social security number into the telephone line to communicate with the social security number telephone central verification computer PIN system to prove ownership of the social security number to unlock its use and authorize the credit card payment. FIG. 15 shows the identity thief has made a purchase on the Internet with a credit card obtained using a stolen social security number. What the identity thief doesn't realize is to expect a phone call from a representative at US Security Link Inc. and/or the Retailer who will ask for proof of ownership of the social security number on the credit card account before merchandise can be paid for and delivered.

“FIG. 16 shows how the social security number telephone central verification computer PIN system will work to verify the legal owner of a social security number when applying for credit over the Internet. FIG. 16 shows a surprised identity thief when the e-business credit card company refuses to begin the credit application process without the identity thief being able to prove legal ownership of the social security number being used to apply for credit. So the e-business is requesting for a phone number so that the identity thief can be called to enter his/her US security code into the telephone line to communicate with the social security number telephone central verification PIN system to verify, authorize and unlock the use of the social security number to receive a credit check and apply for credit. The identity thief in FIG. 16 will not be receiving instant credit because the social security number being used is stolen.

In conclusion I'd like to say the detailed description of the several views of the drawings above demonstrates a few but not all industries to benefit from the social security number PIN system.

Also, The social security number PIN system can be designed in several ways to include biometrics technology and/or a card reader to allow communication with all types of smart cards and/or ID cards to include but not be limited to national ID cards, military ID cards, employee ID cards, student ID cards, credit cards, debit cards, etc. to provide means for individuals to prove ownership of the social security number.

I claim:

1. A Social Security Number Verification PIN system specifically designed to store, verify and protect social security numbers by means in which the individual can choose and enter a secret PIN into a PIN device or telephone line to communicate with the social security number verification PIN system to effect verification and prove ownership of the social security number comprising:
a. Providing means in which the individual is assigned a temporary PIN after legal ownership of the social security number has been properly verified.
b. Providing means in which the individual can choose the secret PIN assigned to protect and lock his/her social security number after the identity is verified using the assigned temporary PIN.
c. Providing means in which the individual enters his/her temporary PIN and social security number into the social security number PIN device to encrypt with computer generated random numbers.
d. Providing means in which the encrypted temporary PIN, social security number and computer generated random numbers can communicate with the social security number verification PIN system to store the individual's personal information permanently to allow the individual to prove ownership of his/her social security number.
e. Providing means in which immediately after the individual enters the social security number and its corresponding temporary PIN into the social security number PIN device, means will be provided in which the individual can choose and enter his/her own secret PIN into the social security number PIN device to encrypt with computer generated random numbers for safe communication with the social security number verification PIN system to store with the individual's previously stored verified personal information permanently.
f. Providing means in which an individual needing to prove ownership of his/her social security number can enter the chosen and assigned secret PIN into the social security number PIN device to communicate with the social security number verification PIN system to match with its corresponding information proving ownership of the social security number.

2. The social security number PIN system as claimed in claim 1 also includes the social security number telephone verification PIN system in which the individual can prove ownership of his/her social security number through telephone lines comprising:
a. Providing means in which an individual is assigned a temporary PIN after legal ownership of the social security number is properly verified.
b. Providing means in which the individual can choose the secret PIN assigned to protect and lock his/her social security number after the identity is verified using the assigned temporary PIN.
c. Providing means in which the individual can enter his/her temporary PIN, social security number and other identifying information into the telephone line to encrypt with computer generated random numbers.
d. Providing means in which the encrypted temporary PIN, social security number, personal identifying information and computer generated random numbers can communicate with the social security number telephone verification PIN system to store the individual's verified personal information permanently.
e. Providing means in which immediately after an individual enters all required verified personal information and its corresponding temporary PIN into the telephone line, means will also be provided in which the individual can choose and enter his/her own secret PIN into the telephone line to encrypt with computer generated random numbers for safe communication with the social security number telephone verification PIN system to store with the individual's previously stored verified personal information permanently.
f. Providing means in which an individual needing to prove ownership of his/her social security number through telephone lines can enter the chosen and assigned secret PIN into the telephone line to communicate with the social security number telephone verification PIN system to match with previously stored corresponding information proving ownership of the social security number.
